(19) United States
(12) Patent Application Publication
(10) Pub. No.: US 2013/0018661 A1
(43) Pub. Date: Jan. 17, 2013

(54) GUEST EXPERIENCE MANAGEMENT SYSTEM AND METHOD

(71) Applicants: John M. Padgett, Clermont, FL (US); Bart D. Butler, Celebration, FL (US); Steven Whittington, Orlando, FL (US); Patrick B. Russell, Orlando, FL (US); Bonnie J. Spivey, Celebration, FL (US); Christy Diaz, Orlando, FL (US); Timothy D. Sypko, Winter Garden, FL (US); Jennifer Pitts Fishpool, Ocoee, FL (US); Roger C. Stevens, Orlando, FL (US)

(72) Inventors: John M. Padgett, Clermont, FL (US); Bart D. Butler, Celebration, FL (US); Steven Whittington, Orlando, FL (US); Patrick B. Russell, Orlando, FL (US); Bonnie J. Spivey, Celebration, FL (US); Christy Diaz, Orlando, FL (US); Timothy D. Sypko, Winter Garden, FL (US); Jennifer Pitts Fishpool, Ocoee, FL (US); Roger C. Stevens, Orlando, FL (US)

(73) Assignee: DISNEY ENTERPRISES, INC., Burbank, CA (US)

(21) Appl. No.: 13/180,490

(22) Filed: Jul. 11, 2011

(51) Int. Cl. G06Q 10/00

(52) U.S. Cl. 705/1.1

(57) ABSTRACT

An exemplary computer implemented method comprises receiving information from a guest, determining a guest strategy based on the information received from the guest, and generating a schedule for the guest visit based on the guest strategy. The schedule for the guest visit may include attendance at one or more experience areas. An exemplary computer system comprises a guest experience manager. The guest experience manager includes a guest interface capable of receiving a communication from a guest computer, where the communication from the guest computer provides guest information. The exemplary guest experience manager also includes at least one business rule for determining a guest strategy based at least in part on the guest information. The computer system also comprises a scheduling element in communication with the guest experience manager. The exemplary scheduling element is capable of scheduling at least on experience based on the guest strategy.

### TECHNICAL FIELD OF THE INVENTION

This invention relates to managing the guest experience at experience areas that could include theme parks, resorts, spas, recreation, cruise line, airport arrival and departure, transportation systems, sporting events, domestic and international guided tours and waterparks in an exemplary embodiment. Exemplary embodiments relate to systems, processes, and methods for applying guest-based business rules to optimize the guest's visit to the experience areas and/or route through a particular experience area based on a guest's pre-selected experiences.

### BACKGROUND

One disadvantage at many theme parks and amusement parks is the long lines that guests face to enter the park, at the attractions within the park, and when purchasing food at mealtimes. Long wait times for attractions in particular detract from the guests experience, not just from the time spent standing in lines, but also by causing the guest to rush from attraction to attraction to maximize the number of popular attractions, without taking time to notice or enjoy the other offerings of the theme park such as music, live entertainment, restaurants, shops, etc.

Additionally, guests that rarely frequent the park are typically unfamiliar with the layout of the park as well as with the peak times for more popular rides. This can further decrease those guests enjoyment, as they may take circuitous routes in order to try and visit as many attractions as possible, and may cause them to experience even longer lines by failing to visit the most popular attractions at off-peak hours.

Different methods have been used to try and minimize wait times in theme parks and amusement parks, including limiting ticket sales on a given day to prevent overcrowding and allowing guests to purchase more expensive express tickets that allow the guest to use shorter express lines for popular attractions. These methods are limited and more prevent overcrowding in the theme park itself, but do not guarantee guests that they will have shorter wait times.

Similarly, other methods to try and minimize wait times in theme parks include allowing guests to appear at the attraction and reserve a specific time in the future when the guest can return to the attraction and enter through an express line. This method is also limited in that it does not allow guests planning their trips to know ahead of time what attractions they will be able to visit on a given day, and what is the best route through the theme park for those desired attractions. Moreover, such systems will typically not allow the guest to make multiple appointments (manifested as flexible return windows)s at the same time. Thus, if the only available appointment times for a popular attraction are late in the day, the guest must either make the appointment and forego the opportunity to make appointments at other attractions, or risk missing the popular attraction entirely.

Accordingly, there is a need for a method and system that better manages the guest experience and the wait times at theme parts, amusement parks and resorts.

### SUMMARY OF THE DISCLOSURE

Methods and systems for managing a guest visit are disclosed. An exemplary computer-implemented method comprises receiving information from a guest, determining a guest strategy based on the information received from the guest, and generating a schedule for the guest visit based on the guest strategy. The schedule for the guest visit may include attendance at one or more experience areas.

The guest experience manager includes a guest interface capable of receiving a communication from a guest computer, where the communication from the guest computer provides guest information. The exemplary guest experience manager also includes at least one business rule for determining a guest strategy based at least in part on the guest information. The computer system also comprises a scheduling element in communication with the guest experience manager. The exemplary scheduling element is capable of scheduling at least on experience based on the guest strategy.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a high level diagram illustrating exemplary components of a system for managing the guest experience at a theme park with attractions;

FIG. 2 is a block diagram illustrating another embodiment of an exemplary system for managing the guest experience at multiple theme parks or resorts to be visited;

FIG. 3 is a diagram of an exemplary architecture for components of the exemplary systems of FIGS. 1 and 2;

FIG. 4 illustrates an exemplary method for a theme park to provide guest experience management based on information received from the guest;

FIG. 5 illustrates an exemplary method creating an attraction schedule for a guest based on information received from the guest; and

FIGS. 6A-6D are illustrative diagrams of screens on a guest computer device for the guest to provide information to exemplary systems of FIGS. 1 and 2.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” “element,” and the like are intended to refer to a computer-related entity, either hardware, firmware, a combination of hardware and software, software, or software in execution. For example, an element may be, but is not limited to being, a process running on a processor, a processor, an object, an executable, a thread of execution, a program, and/or a computer. By way of illustration, both an application running on a computing device and the computing device may be an element.

Similarly, one or more elements may reside within a process and/or thread of execution, and a component may be localized on one computer and/or distributed between two or more computers. In addition, these elements may execute from various computer readable media having various data structures stored thereon. The elements may communicate by way of local and/or remote processes such as in accordance with a signal having one or more data packets (e.g., data from one component interacting with another element or component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities. Therefore, a portable computing device (“PCD”) may include a cellular telephone, a pager, a PDA, a smartphone, a navigation device, a tablet personal computer (“PC”), or a hand-held computer with a wireless connection or link.

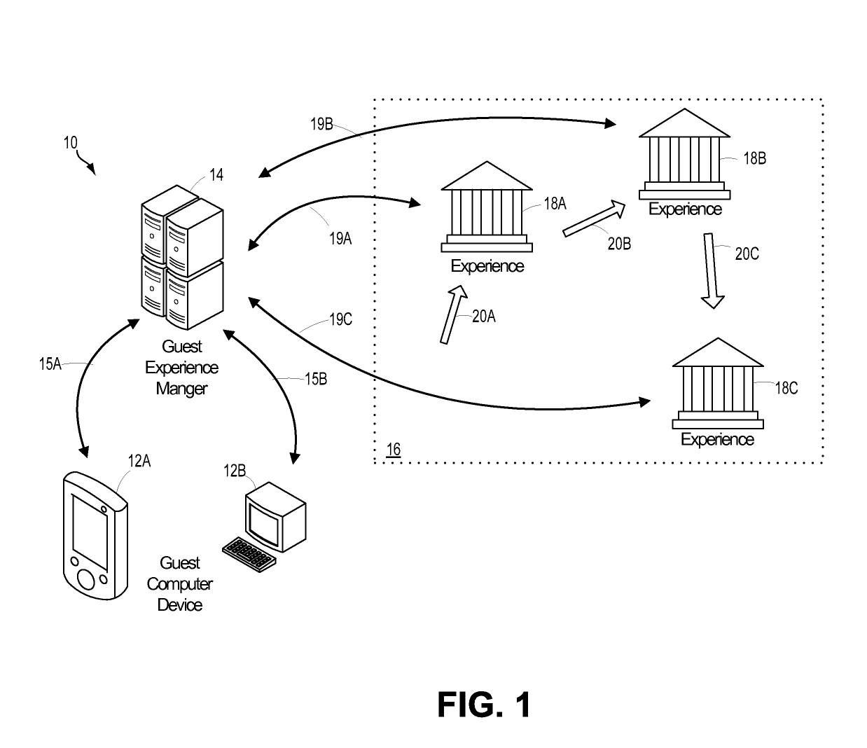

Referring to FIG. 1, this figure is a high level diagram illustrating exemplary components of a system 10 for managing the guest experience in a theme park 16 with experiences 18A, 18B, 18C. As used throughout the application, a theme park 16 may, in an exemplary embodiment, be a collection of experiences 18 that share a common theme or common appeal to a guest. In other embodiments, the theme park 16 could be an amusement park or a resort, where a resort could include a hotel property, a golf course, a spa, a recreation, a cruise line, airport, sporting event, transportation system, guided tour, water park, or the like, or any combination thereof, all of which collectively will be referred to herein as a theme park 16. In such embodiments, for example, the experiences 18 could be restaurants, golf courses, spa treatments, or any combination thereof. In yet other embodiments, the theme park 16 may be a portion or collection of experiences 18 within a larger park or resort.

Similarly, three experiences 18A, 18B, 18C are shown in FIG. 1 for illustrative purposes. In various embodiments, the theme park 16 may more or fewer experiences 18. Additionally, as used in this application the term experience 18 may be or include any combination of rides, shows, recorded or live entertainment, dining, events, or any other amusement that the guest of the theme park 16 desires to visit, see, or participate in. Further, in some embodiments, the experiences 18A-18C may not all be part of the same theme park 16, but instead, for example, experiences 18A and 18B may be in a first theme park 16, while experience 18C is located in, or part of, a second theme park 16′ (not shown).

For example, the theme park 16 could be an amusement park and the experiences 18 could include two rides and a musical performance. In another example, the theme park 16 could be a resort comprising a golf club and the experiences 18A and 18B could be golf courses at the golf club.

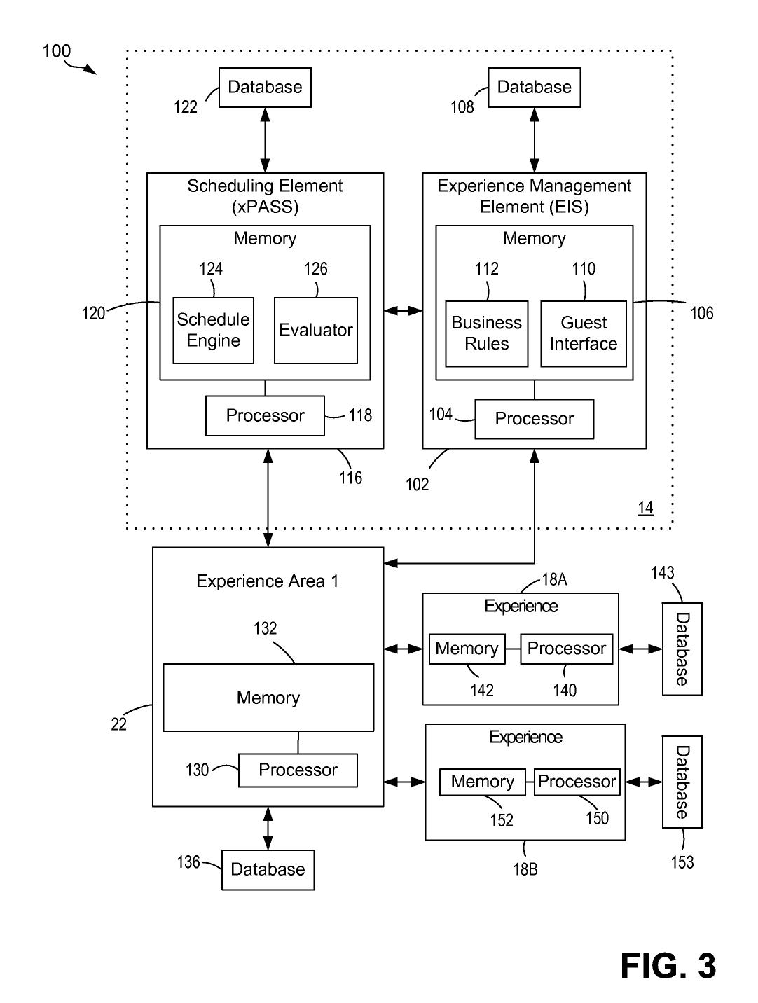

As illustrated in FIG. 1, guests may use a guest computer device 12A, 12B to communicate with a guest experience manager 14 via communication link 15A, 15B. Although illustrated as a server in FIG. 1, the guest experience manager 14 could be an application, code stored in the memory of a computer, or any other component that can receive communications from the guest computer device 12. Additionally, although only a single guest experience manager 14 is illustrated in FIG. 1, in other embodiments the guest experience manager 14 may be comprised of more than one component, element, or server (see FIG. 3). In such embodiments, the multiple components, elements, and/or servers that comprise the guest experience manager 14 may be in communication with each other and/or to the guest computer device 12 through any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and/or a paging network.

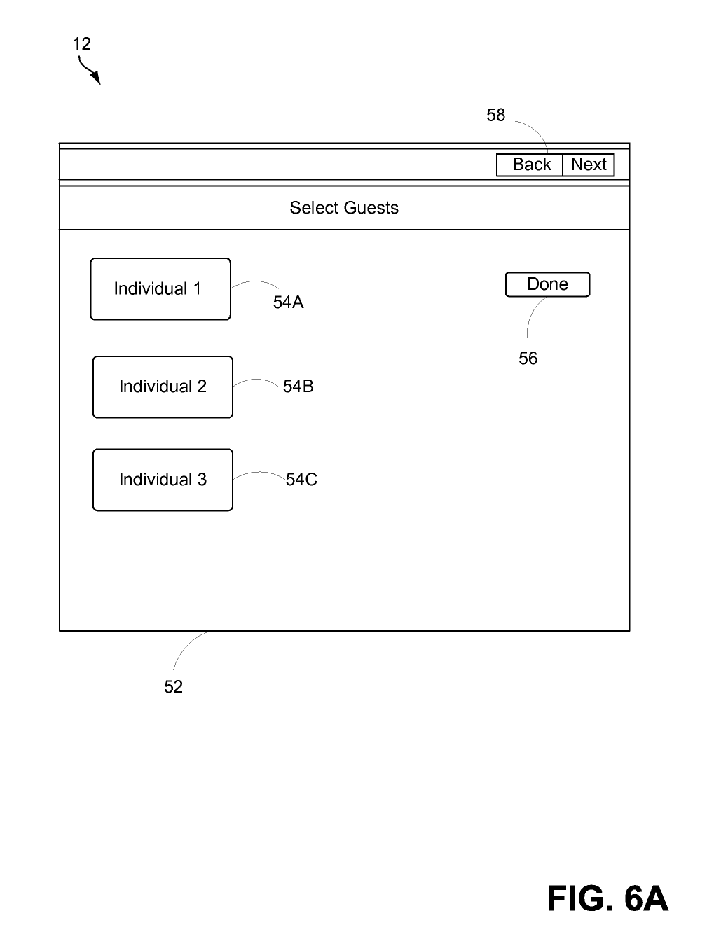

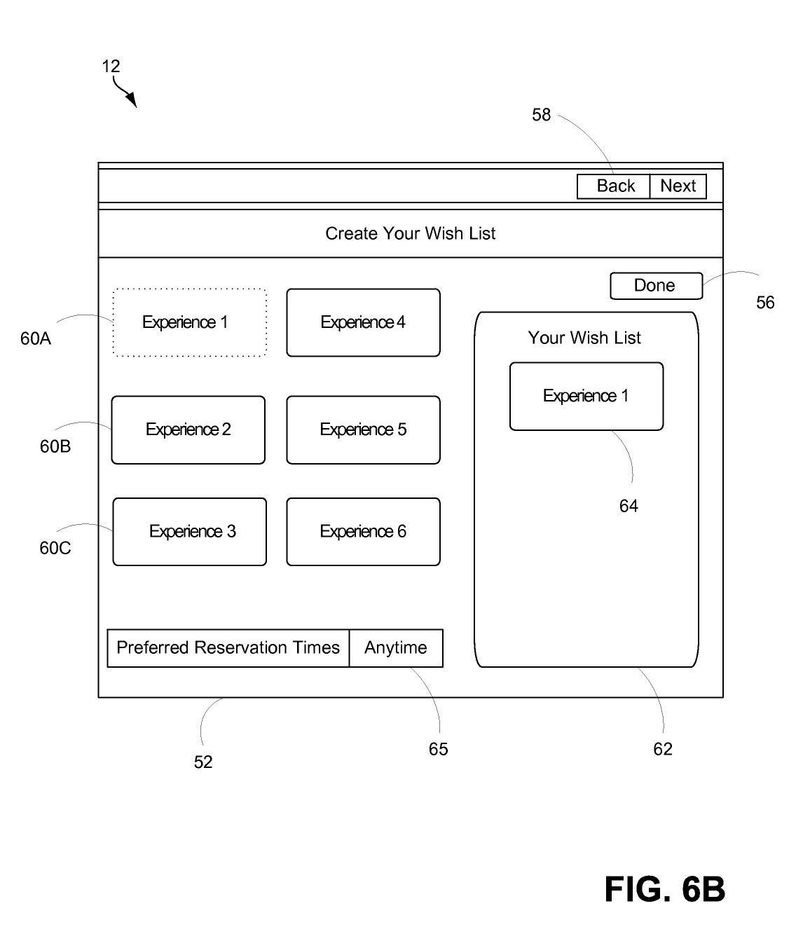

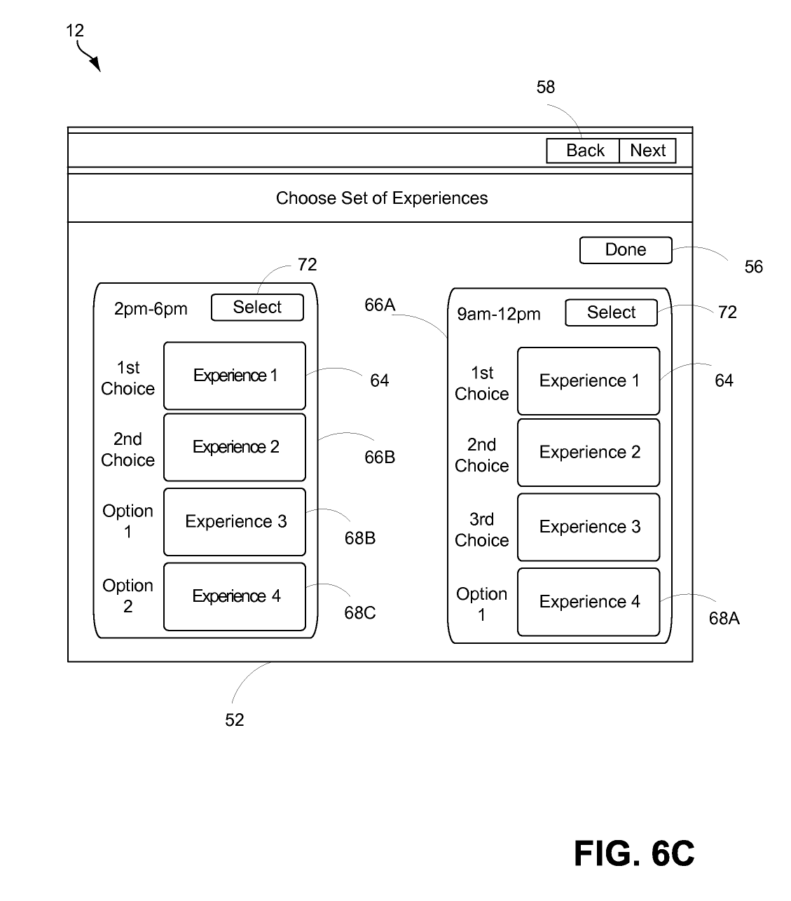

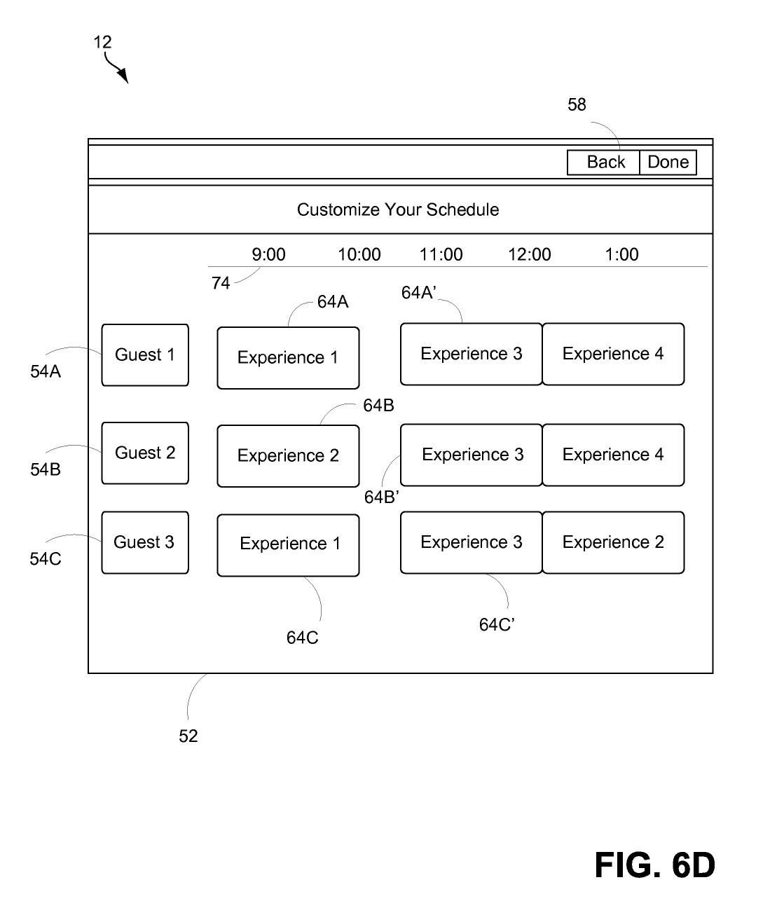

The guest experience manager 14 is also in communication with the experiences 18. In some embodiments the experiences 18 will include a processor, memory, and other components to allow communication with guest experience manager 14. In other embodiments, the guest experience manager 14 will be in contact with a separate computer at or near the location of the attraction (see FIG. 6). Such separate computer could include, for example a PCD in the possession of the attendants at each of the experiences 18, or could include kiosks located at or near the experiences 18. All of these various embodiments of computers in, at, or near the experiences 18C and will be referred to collectively herein as the computer at the attraction 18.

As will be discussed more fully below, one aspect of the system 10 includes allowing the guest to access the guest experience manager 14 via the guest computer device 12 which may be a PCD, desk top computer, other computer, or any combination thereof. In this aspect of the system 10, prior to attending the theme park 16, the guest will select the desired experiences 18 for the day of the visit to the theme park 16, and the system may generate a schedule for experiences 18 based on the input from the guest and various applicable business rules. This schedule sequences the experiences 20 in a manner to optimize the guest's route 20A, 20B, 20C through the theme park 16 in accordance with the applicable business rules.

The schedule will also include appointments (as used herein, “appointments” will include appointments that are manifested as flexible return windows) or passes for the guest for each selected attraction 18 for a time period or window of time that is also optimized in accordance with the applicable business rules as described below. In this manner the guest will be able to pre-select the desired experiences 18 in some embodiments, and when he shows up at the theme park 16, the guest will be able to following an optimized route 20 through the theme park 16. Additionally, the guest will already have appointments or passes for each of the selected experiences 18, without having to rush to an attraction to obtain one appointment or pass for a later time, ensuring that the guest is able to visit the desired experiences 18 according to a geographically optimized route 20, while both minimizing the waiting time at each attraction 18 and allowing the guest to take more time and enjoy the surrounding events, sights, shops, etc. as the guest follows the route 20.

Another aspect of the system 10 may also include tracking of the guest's attendance at each attraction 18 and/or redemption of each appointment. For example, the guest may be issued a ticket to attend the theme park 16, which may be a conventional paper or plastic ticket with the necessary information printed on the ticket. Alternatively, the ticket may be a physical token that is able to communicate with a computer, including, but not limited to integrated circuit cards or “chip cards” such as EUROPAY™, MASTERCARD™ and VISA™ (“EMV”) cards, IC Credit cards, Chip and Pin cards, or the like (collectively referred to herein as “EMV cards”) able to communicate with the computer at the attraction 18 via magnetic fields, or other wireless manner, including sound waves, light waves, radio-frequency communications, etc. In yet other embodiments, the ticket may be virtual ticket that resides on a guest's PCD. For such a physical token or virtual token ticket, information relating to the guest, the guest's schedule and/or the guest's appointments may be stored on the ticket such that the ticket can communicate with the computer at the attraction 18 and/or the computer at the attraction 18 recognizes the guest when he approaches.

In such embodiments, when the guest approaches one of the experiences 18A, the ticket may communicate with the computer at the experience 18A, so as to confirm the guest's appointment for the experience 18A at that time and/or act as a redemption of that appointment. Additionally, such communication with the computer at the experience 18 can serve to monitor how long guests are waiting at the experience 18A, how many guests are in line at the experience 18A at a given time, and may allow the computer at the experience 18A and/or the guest experience manager 14 to determine the available capacity of the experience 18A.

Knowing the available capacity of the experience 18A at a given time can be useful and advantageous for a variety of reasons, including, for example, when the guest arrives at the experience 18A before the time window for his appointment. When the guest's ticket communicates with the computer at the experience 18A, the computer at the experience 18A and/or guest experience manager 14 are notified of the guest's arrival. In this example, the computer at the experience 18A and/or the guest experience manager 14 may check the available capacity of the experience 18A. If the available capacity is below a certain threshold or value, based on specified factors, such as, for example the number of guests at the experience 18A, the popularity of the experience 18A, the time of day (e.g. ramp-up or ramp-down periods in the day), the presence of other events nearby that might affect the crowd at the experience 18A (such as a parade), etc., the guest may be allowed to enter the experience 18A early. Similarly, knowing the available capacity, wait times, number of guests visiting, etc., of each experience 18A, 18B, 18C can be useful for inventory management of the theme park 16, as well as for forecasting or projection of future attendance, predicting peak hours for the experience 18A, etc.

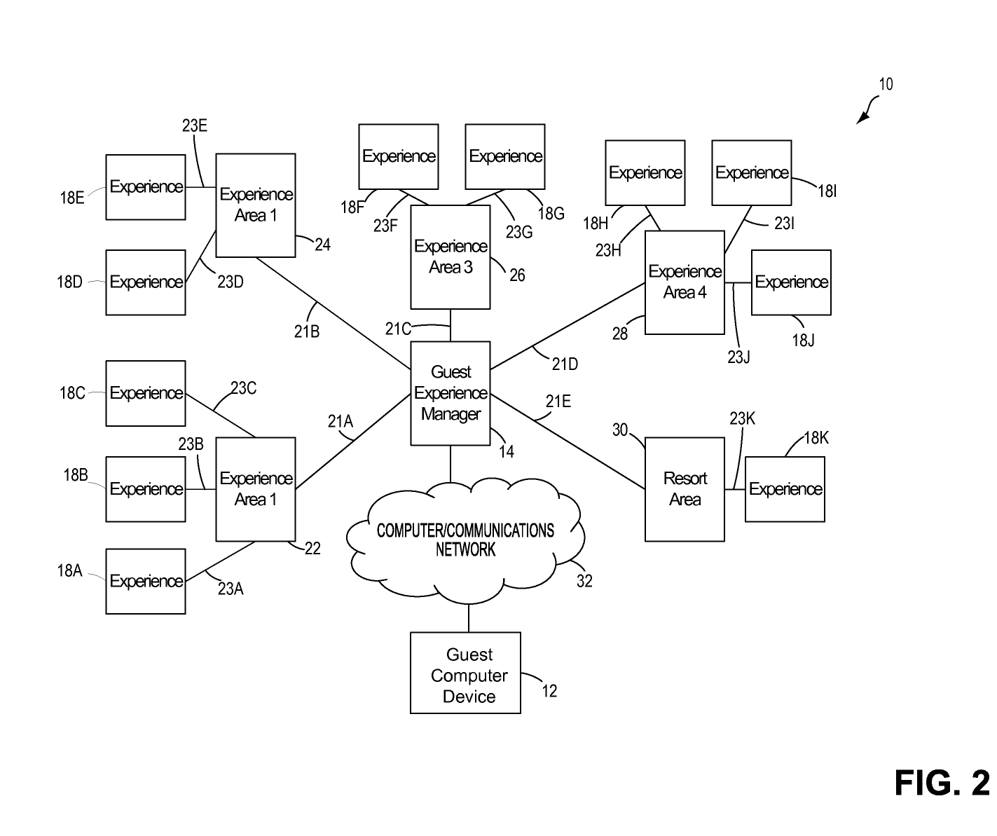

FIG. 2 is a block diagram illustrating another embodiment of an exemplary system 10 for managing the guest experience at multiple experience areas 22, 24, 26, 28 or resorts 30 to be visited. The experience areas 22, 24, 26, 28 or resort 30 may be theme parks, resorts, a hotel property, a golf area, a spa, a recreation, a cruise line, an airport, a sporting event, transportation system, guided tour, water park, or the like, or any combination thereof. In this exemplary embodiment the system 10 includes a guest experience manager 14 that is connected to and in communication with a computer/communications network 32 such as the internet. The guest experience manager 14 illustrated in this embodiment is a single component, however, in other embodiments the guest experience manager 14 may be comprised of more than one component, application and/or server (see FIG. 3). Additionally, the guest experience manager 14 in the exemplary embodiment shown in FIG. 2 is in communication with experience areas 22, 24, 26, 28 (referred to in the collective as experience areas 22 for convenience) and resort 30 via communication lines 21A-21E.

In this embodiment, rather than communicating directly with the experiences 18A-18K or computers at the experiences 18A-18K, the guest experience manager 14 communicates with the experience areas 22 and/or resort area 30 as illustrated in FIG. 2. This communication may be with a component, application, server, computer, or other element designated for and/or located at each of the experience areas 22, 24, 26, 28 and resort area 30. In alternative embodiments, one or more of the experience areas 22 and/or resort area may not be separate designated or dedication components, applications, server, etc., but may instead be portions of one or more component, application, server, computer, or other element designated for some or all of the experience areas and/or resort area 30. Additionally, in the case of designated component, application, server, computer, or other element for the experience areas 22 and/or resort area 30, such designated component, application, etc., may be collocated, or may be located at, in, or near its corresponding experience area 22 and/or resort 30.

Each of the experience areas 22, 24, 26, 28, 30 is in communication with one or more experiences 18A-18K via secondary communication lines 23A-23K as illustrated in FIG. 2. As discussed above, each experience 18 may include a processor, memory, and other components to allow communication with their respective experience areas 22. In other embodiments, the experience areas 22 will be in communication with a separate computer at or near the location of the experiences 18 (see FIG. 6). Such separate computer could include, for example a PCD in the possession of the attendants at each of the experiences 18 or could include kiosks located at or near the experiences 18.

Although illustrated in FIG. 2 as separate, one or more of the experience areas 22 could be portions of a larger experience area, park, resort, etc. There also may be more or fewer experience areas 22 and/or resort areas 30 than the number in the exemplary embodiment illustrated in FIG. 2. Similarly, each experience area 22 and/or resort area 30 may have more or fewer experiences 18 than those illustrated in FIG. 2. Although the experience areas 22 are shown separately from the resort 30 in FIG. 2, this is for illustrative purposes and an experience area 24, for example, may be a resort area 30, and vice versa.

Each of the communications links 21 and/or secondary communications lines 23 may be wired or wireless links including, but are not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network. For instance, although communication lines 21 are shown as directly connected to the guest experience manager 14, one or more of the communication lines 21 could be connected to the guest experience manager 14 through a computer/communications network 32, including, for example, the Internet.

One aspect of the system 10 includes allowing the guest to access the guest experience manager 14 via the computer/communications network 32 using the guest computer device 12, which may be a PCD, other computer, or any combination thereof. In this aspect of the system 10, prior to attending the theme park 16, the guest will be able to select the desired experience areas 22 and/or resort areas 30, as well as desired experiences 18 for visits for visits on one day, or over multiple days. Based on the inputs from the guest, the system 10 may generate a schedule for the selected experiences 18 in accordance with various applicable business rules. This schedule sequences the selected experiences 18 in a manner to optimize the guest's routes 20 (see FIG. 1) through various experience areas 22 and/or resort areas 30 over one or more days in accordance with the applicable business rules.

The schedule will also include appointments for the guest for each selected attraction 18 for a time period or window of time on the designated day, which is also optimized in accordance with the applicable business rules as described below. Similarly, the selection of which among multiple experience areas 22 and/or resort areas 30 will be visited in each particular day of a multi-day visit may also be optimized in accordance with the applicable business rules.

In this manner the guest will be able to pre-select the desired experiences, 18A, 18B, 18C, 18D, and 18E for instance, to be visited over two days. The guest will receive a schedule advising which experience area will be visited on each day, and when he shows up at the experience area 1 22 on the scheduled day, the guest will be able to following an optimized route 20 (see FIG. 1) through experience area 1, ensuring that the guest is able to visit the desired experiences 18, while minimizing the waiting time at each experience 18 on each day of the visit.

Another aspect of the system may also include tracking of the guest's attendance at each attraction 18 and/or at each experience area 22 and/or resort area 30 in a manner similar to that discussed above. For example, the guest may be issued a ticket to attend a experience area 2 24, which includes experiences 18D and 18E, on a first day; to attend a resort area 30 (in this example a golf resort) which includes experience 18K (in this example a golf course) on the second day; and to attend experience area 4 28, which includes experiences 18H, 18I, and 18J, on a third day. In some embodiments the guest may receive a separate ticket each day, while in other embodiments the guest may receive one ticket that is used for two or more days.

The ticket(s) may be a conventional paper or plastic ticket, or may be a physical token that is able to communicate with a computer, including, but not limited to an EMV card, that is able to communicate with the experiences 18D-18E and 18H-18J via magnetic fields, or other wireless manner, including sound waves, light waves, radio-frequency communications, etc. Alternatively, the ticket may be virtual ticket that resides on a guest's PCD. For such a physical or virtual token ticket, information relating to the guest, some or all of the guest's schedule and/or some or all of the guest's appointments may be stored on the ticket such that the experiences 18 or computers at the experience 18 “recognize” the guest when he approaches.

In such embodiments, when the guest approaches one of the experiences 18D, the ticket may communicate with the computer at the experience 18D, so as to confirm the guest's appointment for the experience 18D at that time and/or act as a redemption of that appointment. Additionally, such communication with the computer at the experience 18D can server to monitor how long guests are waiting at the experience 18D, how many guests are in line at the experience 18D at a given time, and may allow the computer at the experience 18D, a computer at experience area 2 24, and/or the guest experience manager 14 to determine the currently available capacity of the experience 18D as discussed above.

Turning to FIG. 3, an exemplary architecture 100 for some components of the embodiments the systems 10 of FIGS. 1 and 2 are illustrated. In the exemplary architecture 100, the guest experience manager 14 is comprised of an experience management element 102 in communication with a scheduling element 116. The experience management element 102 illustrated in FIG. 3 is a component that includes a processor 104 in communication with a memory 106. In other embodiments, the experience management element 102 may include multiple different memories 102 in communication with one or more processor 102. The experience management element 102 may also be in communication with one or more database 108 located either internally within (not shown) or externally to the experience management element 102. Alternatively, the experience management element 102 may not have a processor 104 or memory 106, but instead may be an application that resides in the memory of come larger component, computer, etc.

Similarly, the scheduling element 116 illustrated in FIG. 3 is a component that includes a processor 118 in communication with a memory 120. In other embodiments the scheduling element 116 may include multiple different memories 120 in communication with one or more processor 118. The scheduling element 116 may also be in communication with one or more database 122 located either internally (not shown) or externally to the scheduling element 116. Alternatively, the scheduling element 102 may not have a processor 104 or memory 106, but instead may be an application that resides in the memory of come larger component, computer, etc.

Although shown as two separate elements, the scheduling element 116 and the experience management element 102 may be separate portions of the same element, component, application, computer, server, etc., and/or may reside together in separate portions of the memory of one component, application, computer, server, etc.

The guest experience manager 14 illustrated in FIG. 3 is in communication with the experience area 1 22, although in other embodiments there may be multiple experience areas 22 and/or resort areas 30 in communication with the guest experience manager 14 (see FIG. 2). In the exemplary architecture 100 illustrated in FIG. 3, both the scheduling element 116 and the experience management element 102 may be in communication with the experience area 22. In other embodiments only one of the scheduling element 116 or experience management element 102 may be in contact with the experience area 22. In the embodiment illustrated in FIG. 3, the experience area 22 includes a computing device with a processor 130 coupled to a memory 132. The experience area 22 may also be in communication with one or more databases 136 located either internally (not shown) or externally to the experience area 22. The experience area 22 is in communication with experiences 18A, 18B, although in other embodiments, the experience area 22 may be in communication with fewer or more experiences 18A, 18B (see FIG. 2). Within each experience 18A and 18B illustrated in FIG. 3, or in at or near, the experience 18 and 18B is a computing device including a processor 140, 150 in communication with a memory 142, 152 respectively.

The memory 106 of the experience management element 102 illustrated in FIG. 3 contains guest interface 110 information and various business rules 112. Additional information may also be located in the memory 106 that is part of, controlled by, and/or accessed by the experience management element 102 in the embodiment of FIG. 3. The guest interface 110 contains instructions, information and/or logic to allow the guest experience manager 14 to communicate and interact with guests at various times during the process of initiating, creating, or modifying a schedule for a visit to one or more experience areas 22 and/or resort areas 30, as will be discussed more fully below.

The business rules 112 are used by the experience management element 102 to manage and plan the guest's experience in his visit to the desired experience areas 22 and/or resort areas 30. When the guest communicates with the experience management manager 14 in order to plan a visit to one or more of the experience areas 22 or resort areas 30 (see FIGS. 1, 2, 4A-4D), the guest's information is provided to the guest interface 110. Based on the information received by the guest interface 110, the business rules 112 act to determine the strategy and/or parameters that the scheduling experience management element 102 and/or scheduling element 116 apply when generating the optimized schedule and/or optimized routings 20 for the guest.

Examples of the strategy that the scheduling element 116 may apply based on the business rules 112 include narrowing or widening time windows depending on whether the guest is planning to visit a theme park 16 for one day (widening the time windows to maximize the time the guest sends in the park) or for multiple days (narrowing the time windows in order to allow the guest to take return to their room during the day). Examples of parameters set by the business rules 112 may include setting the weight that the scheduling element 116 will give to various components or elements of the scheduling process used to optimize the guest's route 20 through one or more experience area 22 or resort area 30 (see FIG. 1).

There may be any number of business rules 112, and the business rules 112 may be grouped together into different categories in some embodiments. For instance, ticket business rules 112 may include different rules that apply depending on whether the guest is purchasing a one day ticket for experience area 2 24, or a multi-day ticket to multiple experience areas 22, 24, 26. Such ticket business rules 112 may also include differing rules that apply based on whether the guest will be staying on site at a hotel located at one of the experience areas 22, or will be driving each day to the experience areas 22.

By way of another example, guest business rules 112 may include differing rules depending on who the guest is, how many people are in the guest's party, the ages of the members of the guest's party, whether there are records that the guest has visited certain experience areas 22 or experiences 18 in the past, whether past records indicate that the guest desires to see certain characters at a specific experience area 22, eat at certain restaurants, etc. Additional types and kinds of business rules 112 may also be applied to achieve a desired strategy for the guest's visit in other embodiments.

The exemplary scheduling element 116 illustrated in FIG. 3 is a component including a memory 120 which includes a schedule engine 124 and an evaluator 126. Additional information may also be located in the memory 120 of the scheduling element 116. The schedule engine contains instructions, information and/or logic to allow the scheduling element 116 to create the optimized schedule for a specific set of experiences 18 provided by the experience management element 102. In other embodiments, the scheduling element 116 may create the optimized schedule when the experience management element 102 has not provided a specific set of experiences 18. The exemplary schedule engine 124 determines the available inventory of experiences 18A at the experience area 22 on the day the guest wishes to attend and creates a schedule of the desired experiences 18 as discussed below.

These schedules may then be reviewed and/or scored by an evaluator 126, in accordance with the strategy and/or parameters provided by the experience management element 102. The appropriate weight is given to the various factors such as total distance of the path travelled, the time buffer between attractions, etc., to determine a score for a particular schedule. The evaluator 126 places schedules achieving a threshold score into a result that can be returned to the experience management element 102.

In the embodiment illustrated in FIG. 3, the experience management element 102, either through the guest interface 110 or some other component or logic, will review the schedule of attractions for conflicts with other events such as dining experiences or other leisure activities. In the event of conflicts, the experience management element 102 may apply the business rules 112 to determine how to resolve the conflict, and may communicate the results including an optimized schedule for a visit to one or more theme parks 16 to the guest, which in the illustrated embodiment, may be accomplished by the guest interface 110. In some embodiments, the results returned to the guest may require the guest to make choices, or to provide additional information to allow the experience management element 102 and/or scheduling element 116 to provide complete or better results.

Accordingly, rather than providing generalized schedules of experiences 18 to be visited during a guest's visit, the exemplary embodiment of the experience management element 102 may gather information about the particular guest and may apply various sets or groups of business rules 112 to create an optimized schedule for the guest's visit. For visits to a particular experience area 22 as part of the guest's visit, rather than providing a generalized order of experiences 18 to be visited by the guest, the business rules 112 cause the illustrative scheduling element 116 to create a routing 20 for each experience area 22 visited that is individually optimized for the particular guest's visit. Finally, the embodiment of the experience management element 102 of FIG. 3 also ensures that a schedule returned by the scheduling element 116 provides no conflicts with the guest's additional activities away from the experience area 22, such as dining or other leisure activities (such as golf, spa treatments, etc.) and assists with resolving such conflicts based on the business rules 112.

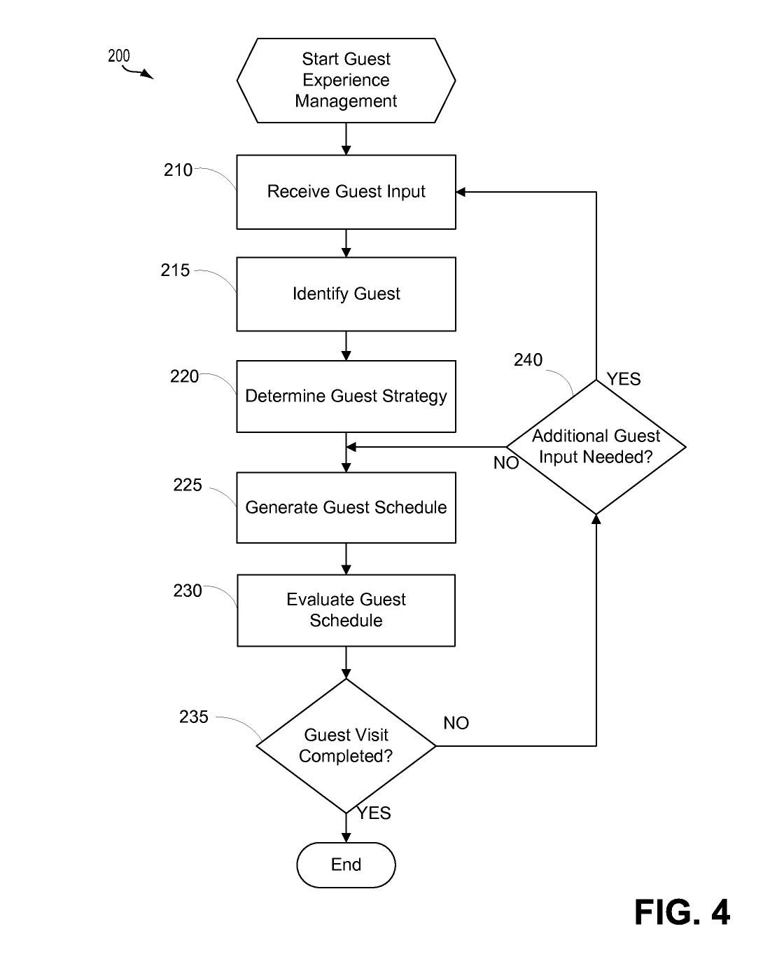

Turning now to FIG. 4 an exemplary method 200 to manage the guest experience management is illustrated. The method 200 begins with the receipt of guest input 210. As discussed above, the guest may provide this input via a guest computer device 12, including a PCD. Additionally, the amount and type of information received from the guest may vary depending on the guest and the type of experience desired by the guest. In one embodiment, the input received from the guest at step 210 will at least include one or more experiences 18 for at least one experience area 22 that the guest wishes to visit, see, participate in, partake in, experience, etc. In other embodiments, input received from the guest at step 210 the guest will not list any experiences 18, but may include at least one experience area 22 that the guest wishes to visit, see, participate in, partake in, experience, etc.

In the exemplary embodiment discussed below in relation to FIGS. 6A-6D, the guest input is received 210 via a series of screens displayed on the guest's computer device 12 with prompts causing the guest to provide the necessary information as the appropriate time. However, other methods of receiving information from a guest computer device, including a PCD may be used to receive guest input 210.

After receiving the guest input 210, the guest is identified 215. Identifying the guest may include validating that the guest has not exceeded a threshold number of bookings or pending appointments that have not been paid for. In the exemplary embodiment, a guest may make multiple alternative appointments for the same time frame. However, each such appointment causes a decrease in the available experience area 22 inventory, including a decrease in the inventory of available experiences 18 that other guests may wish to reserve. Accordingly, identifying the guest 215 may also include ensuring that the guest does not have more than a pre-determined number of pending appointments.

Additionally, identifying the guest 215 may include in some embodiments reviewing memories, databases, or other storage medium for information about the guest from previous visits. Similarly, identifying the guest 215 may also include identifying the number of individuals in a guest's party and/or whether any individuals in the guest's party have current appointments that need to be taken into account when scheduling experiences 18 for the entire guest party.

Once the guest is sufficiently identified 215, the guest strategy is determined 220. Using the embodiment illustrated in FIG. 3 as an example, the guest strategy may be determined 220 by determining the appropriate business rules 112 to apply based on the identity of the guest from 215, and applying the business rules 112 to the guest input from 210. Any number of business rules 112 may be applied to achieve a desired goal for the guest. For instance, a guest comprised of three adult female friends attending a experience area 22 on one day and a spa resort 30 on a second day, will require application of one set of business rules 112 to determine a first strategy in accordance with 220. However, a guest comprised of a family with two young children accompanied by grandparents planning to visit the same experience area 22 over two days may require application of some of the same business rules 112 as the first example, but also some additional business rules 112, generating a very different guest strategy in accordance with 220.

Additionally, continuing to use the embodiment of FIG. 3 as an example, the business rules 112 applied and the guest strategy determined at 220 may depend at least in part on the goals of others besides the guest. For instance, the goals of the experience area 22 and/or the owner of the experience area 22. As an example, determining the guest strategy in accordance with 22 may include application of business rules 112 such as guests that pay with a co-branded credit card are allowed earlier access to certain experience areas 22 and/or to certain experiences 18 than other guests may be allowed. Similarly, guest strategy determined in accordance with 220 for guests on a one-day pass may include expanding the time windows to keep the guest at the park longer and creating schedules that place the guest near popular restaurants at mealtimes.

In alternative embodiments, determining the guest strategy at 220 may also take into account other factors such as already existing appointments for other guests for the same day that the current guest wishes to visit, expected crowd levels, expected peak times for the various experience areas 22 that the guest has selected, etc. In such embodiments, determining the guest strategy at 220 may also be used to balance the attendance at experience areas 22 on given days and/or improve utilization of the experiences 18 across the various experience areas 22. By way of example, determining the guest strategy at 220 for the particular guest may take into account the typical bottlenecks across the experience areas 22, such as at the normal opening hours when guests crowd the entrances to try and rush to popular experiences 18 and set parameters that ensure that the guest's visit schedule does not cause the guest to enter a particular experience area 22 until after the morning crowd has typically subsided.

Once the guest strategy is determined at 220, a guest schedule is generated in accordance with 225. Using the embodiment illustrated in FIG. 3 as an example, generating the guest schedule at 225 may include providing information to the scheduling element 116 and engaging the schedule engine 124 to determine a schedule of experiences 18 at an experience area 22. Additionally, generating the guest schedule in accordance with 225 may also include determining the availability of, and planning times for desired dining experiences or leisure activities (such as golf outings or spa treatments) in addition to, or instead of, a visit to the experience area 22 to enjoy a list of desired attractions 18.

Once the guest schedule is generated 225, the method 200 evaluates the guest schedule at step 230. For the embodiment illustrated in FIG. 3, evaluating the guest schedule 230 may include determining whether a generated schedule of experiences 18 at an experience area 22 conflicts with other activities that the guest desires. Additionally, evaluating the guest schedule at 230 may also include taking action, including making exceptions to some of the business rules 112 to remove the determined conflict.

For example, in the event that a generated schedule of experiences 18 conflicts with a planned dining event, evaluating the guest schedule at 230 may also include resolving the conflict by moving the dinner so that a more desirable schedule of experiences 18 at an experience area 22 may be selected. Alternatively, the conflict may be resolved by selecting one of the less desirable experience 18 schedules, and keeping the dinner plan intact if it is determined that the dinner is more important to this particular guest. In some embodiments, evaluating the guest schedule in accordance with 230 may also include evaluating the schedules of individuals within the guest party against each other, in order to identify and/or remove conflicts among the members of the party.

Once the guest schedule has been evaluated at 230, the method 200 determines whether the guest visit is completed at 235. Determining whether the guest experience is completed in accordance with 235 may include determining whether all of the desired events, leisure activities, and/or visits to experience areas 22 have been scheduled. For instance in the event of a multi-day visit to more than one experience area 22, the method may need to create more than one schedule of experiences 18, using the schedule engine 142 for example. In other embodiments, determining whether the guest visit is complete may include determining whether attempts to schedule the guest visit have not succeeded such that additional guest input is needed. If the guest experience has been completed, in accordance with 235 the guest schedule is presented to the guest and the method ends.

In the event that the guest experience has not been completed, in accordance with 235 the method 200 determines whether additional guest input is needed 240. Additional guest input could include in some embodiments, missing information that the guest neglected to provide in the first place, or may include providing additional guest input in the event that multiple experience 18 schedules are returned and the guest needs to choose one. If additional guest input is needed in accordance with 240, the method 200 returns to step 210 and receives guest input.

Alternatively, in some instances at 240, it may be determined that guest input is not needed. Using the example of a multi-day visit to more than one experience area 22, the method 200 may need to engage the schedule generator 124 of FIG. 3 more than once to generate optimized schedules for more than one experience area 22. In such embodiments, it may be determined at 240 that additional guest input is not needed to generate the experience 18 schedule for the second experience area 24, and the method will return to the step of generating the guest schedule 225 to continue with scheduling.

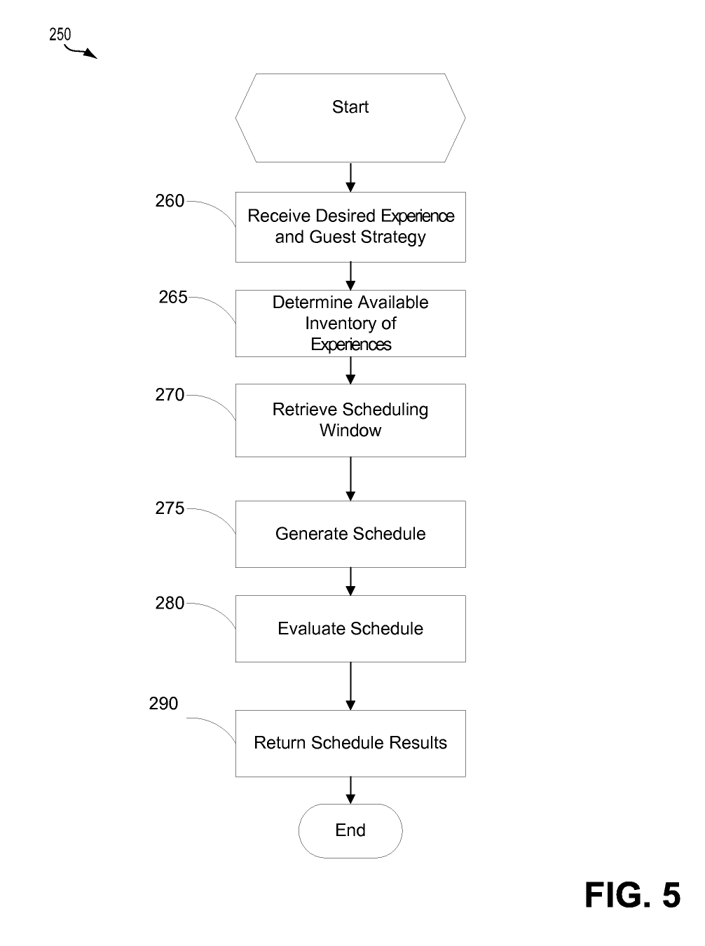

FIG. 5 illustrates an exemplary method 250 for generating an experience schedule (such as may be accessed as part of generating the guest schedule at step 225 of the method 200 illustrated in FIG. 4). In accordance with 260, the exemplary method begins with the receipt of a list of desired experiences 18, as well as the guest strategy to be applied when building a schedule. In other embodiments the exemplary method may start with the receipt of the guest strategy to be applied when building a schedule, but without a list of desired experiences 18. In an exemplary embodiment, the guest strategy may include information that informs the experience schedule generation method 250 of the weight to give to certain factors when determining the most desirable schedule. Similarly, the guest strategy may include parameters and values that the experience scheduling method 250 may use to score the schedules generated.

In the exemplary method 250 illustrated in FIG. 5, an inventory of available experiences 18 is first determined Depending on the implementation or the timing of the guest's request, the available inventory of experiences 18A, 18B can be determined based on projections or estimations from historical data, including the particular day, time of day, existence of other events that may draw guests to or away from an experience 18, as well as from other appointments that have been made for that experience 18 at the same time. In other embodiments, when the guest is attempting to create a schedule on the day of the visit, such as from the guests PCD while at, or on the way to, an experience area 22, the available inventory of experiences 18 may be based on the available capacity of the experience 18 at the desired time.

Once the available inventory of experiences 18 is determined in accordance with 265, scheduling windows are retrieved at 270. The parameters of the scheduling windows retrieved may depend on the guest strategy being pursued, which in some embodiments may serve to lengthen or shorten the applicable scheduling windows depending on the guest strategy. Additionally, in some embodiments, the scheduling windows retrieved may also be based on the number of days that the guest will be visiting an experience area 22, the amount of available experience 18 inventory on the day the guest wishes to visit and experience area 22, etc. For instance, using the embodiment of FIG. 3 as an example, for a guest visiting one theme park on a single day visit, retrieving the scheduling windows in accordance with 270 may comprise the scheduling element 116 causing the schedule engine 124 to lengthen the windows of time between the selected experiences 18, spreading the experiences 18 out over the entire day. On the other hand, for a guest staying on site at the experience area 22 over multiple days, the strategy information and/or parameters may dictate that the schedule engine 124 shorten the windows of time between experiences 18 to allow the guests more flexible time to enjoy their accommodations at the experience area 22.

After the scheduling windows are retrieved in accordance with 270, the available inventory of experiences 18 may be applied to the scheduling window to generate a schedule at 275. In the exemplary embodiment, the schedule is generated based on a logical geographic sequence of the attractions, taking into account a variety of guest factors or components, including the geography of the experience area 22, the distance between the experiences 18, the sequence of the experiences 18 that provides the least total distance travelled, the time needed to ride or participate in each particular experience 18, the time needed to travel between experiences 18, etc. The weight given to each of the guest factors, and in some embodiments, the inclusion and/or exclusion of certain guest factors in the determination of the logical geographic sequence, depends on the guest strategy received at 260.

Additionally, in some embodiments, creating the geographic sequence can also take into account other factors, such as already existing appointments for other guests at that experience area 22 on the same day that the current guest wishes to visit, expected crowd levels at that experience area 22 at various times of the day, additional events (such as parades) that might prevent travel along certain streets of the experience area 22 at certain times of the day, etc. In such embodiments, generating the schedule of experiences 18 in accordance with 270 may also be used to assist with controlling the crowd flow within the particular experience area 22, allowing better flow of the guest through the experience area 22, distribution of the crowd to different experiences 18 at particular times, and/or reducing known crowd bottlenecks within various locations of the experience area 22 at various times of the day.

In the event that a complete schedule including all of the experiences 18 desired by the guest cannot be generated or in the event that the guest did not provide desired experiences 18 and a complete schedule cannot be generated, additional alternative schedules will be generated. For instance, in the event of the unavailability of one or more of the desired experiences 18 at the desired time of day provided by the guest, additional alternative schedules will be generated. Generation of the additional schedules will attempt to find the best alternative schedule in accordance with the guest strategy. In some embodiments, this may include generating multiple alternative schedules. Such multiple alternative schedules may include substituting an alternate attraction 18A for the unavailable desired attraction 18B where the alternate attraction 18A may be selected based on geographic proximity to the unavailable desired attraction 18B, based on similarity to the unavailable desired attraction 18B, or based on any other desired factor, such as factors determined by business rules 112 and/or a guest strategy (See. FIGS. 3, 4).

In the exemplary embodiment, once a pre-determined number of alternative schedules have been generated in accordance with 275, the schedules are evaluated at 280 using the guest strategy received at step 260, to create a list of results having the highest scores. Evaluating the schedules may include giving numeric values to various components of the schedule, applying a scoring weight based on the guest strategy, and adding the values of the components together to determine which schedule scores highest.

For example, using the embodiment of FIG. 3, the schedule engine 124 may generate a predetermined number of potential schedules. These schedules may then be scored by the evaluator 126, in accordance with the strategy and/or parameters provided by the experience management element 102. In some embodiments, this may include scoring each schedule by: calculating the total distance travelled in a schedule; calculating the time buffer between attractions and assigning points depending on the length of the buffer; calculating the total elapsed time in a schedule; assigning points for each of the desired experiences 18 selected by the guest in a particular generated schedule; assigning less points for any substituted experiences 18 in a schedule, based on the quality of the substitute; etc., and then adding together to determine a score for a particular schedule. In some embodiments, each factor discussed above may be multiplied by an applicable scoring weight in accordance with the guest strategy, or some of the factors may not be considered at all. The schedules with the highest scores are added to the results to be returned to the guest. Additional methods of evaluating the schedules may also be used.

In this manner, the method 250 may take alternative approaches to generate the schedule results that will be returned at 290 if desired. In some embodiments, returning the schedule results at 290 may include returning a predetermined number of the highest scoring schedules to whatever application or program forwarded the desired experiences 18 and guest strategy at step 260 (such as in embodiments when method 250 is being implemented as part of the step of scheduling a guest visit 255 in the exemplary guest experience management method 200 illustrated in FIG. 4). In other embodiments, returning the results at 290 may include forwarding the results directly to the guest for the guest to either book one of the resultant schedules, or for the guest to provide additional input to allow the method 250 to reiterate and generate new schedule results.

Referring to FIGS. 6A-6D, these illustrative diagrams of screens 52 on a guest computer device 12 for the guest to provide information to exemplary systems of FIG. 1 or 2 and/or for use in the exemplary methods of FIG. 4 or 5. FIGS. 6A-6D are exemplary diagrams of screens 52, and in some embodiments only some, or none of the screens 52 illustrated in FIGS. 6A-6D may be used and/or different information may be presented or solicited in alternative screens 52. Additionally, the screen 52 may be displayed on a guest computer 12 monitor, including a PCD, or on a kiosk that the guest is using. The exemplary screen 52 in FIG. 6A lists options for selecting or adding individuals 54A-54C to a guest party. Although three individuals 54 are shown in FIG. 6A, some guest parties may have only one or two members, while other guest parties could have many more than the three individuals 54 shown in FIG. 6A for illustrative purposes. A variety of information may be associated with each individual 54 by selecting an individual 54, whether by touching on a touch screen, using a mouse or other pointer to select the individual 54, or by other means. Once an individual 54 is selected, the screen 52 may display a prompt for the individual 54 to enter information, may cause a pop-up to appear where the individual 54 may enter information, or may otherwise solicit information about the individual.

The screen may also include navigation buttons 58 to allow a guest, or an individual 54 to navigate to subsequent or previous screens 52 as desired. Additionally, the screen 52 may include an acceptance button 56 that may be selected or activated when all of the individuals 54 have been associated with the guest party and/or have entered all of their required information. Once the acceptance button 56 is selected, the guest party will be completed, and the navigation button 58 may be selected or activated to proceed to the next screen illustrated in FIG. 6B.

FIG. 6 B shows an exemplary screen 52 on a guest computer device 12 allowing the guest to create a wish list 64 of experiences 18 associated with an experience area 22. The wish list 64 will be used by the system 10 and/or methods 200, 250 to generate the guest's schedule. In the embodiment illustrated in FIG. 6B, experience buttons 60A-60C are displayed on the screen 52, representing the experiences 18 at an experience area 22. The guest may add a predetermined number of experiences 18 by selecting or activating the corresponding experience button 60 to create a selected experience 64 in the wish list 62. In other embodiments, the experience buttons 60 may be dragged-and-dropped into the wish list 62. Additionally, the guest will be allowed to provide a desired window of time using the time selector button 65. The guest could select anytime, morning, mid-day, afternoon, evening, or any other desired time frame for the selected experiences 64 to be scheduled.

In some embodiments, the guest will be free to select any of the experience buttons 60 to create the wish list 62, up to the predetermined limit on the number of selected experiences 64. In other embodiments, the experience buttons 60 may be grouped or tiered, with the guest only allowed to select no more than a certain number from each group or tier. Additionally, when the wish list 62 is completed, the acceptance button 56 may be selected to complete the wish list 64. In embodiments where the guest includes multiple individuals 54 (FIG. 6A), selecting the acceptance button 56 may allow the next individual 54 to create a wish list 62. When all of the wish lists 62 are created, the navigation buttons 58 may be selected to move to previous or subsequent screens 52. In some embodiments, creation of the wish list 62 will be sufficient for the system 10 and/or exemplary methods 200 or 250 to operate to generate a schedule for the guest. In other embodiments (not shown) there may be additional screens to select or provide additional information, such as choosing desired restaurants, events, leisure activities, etc. that will be part of the guest's visit.

In yet other embodiments, rather than creating a wish list 62, a pre-selected or pre-determined wish list 62 of selected experiences 64 may be displayed to the guest. In such embodiments, the pre-determined or pre-selected wish list 62 may be generated based on other information that the guest provides, or may represent pre-selected wish lists 62 of most popular, highly rated, or other groupings of selected experiences 64. For example, if the guest party includes one or more small children, pre-selected wish lists 62 comprising experiences 18 targeted at small children may be displayed on the screen 52, that allow a guest to select the wish list, without having to individually select experiences 18, providing for a fast and easy “one click” selection of a wish list 62.

FIG. 6C illustrates an embodiment of a screen 52 that displays at least part of the results of a schedule generation. In the embodiment shown in FIG. 6C, two experience schedule results 66A, 66B are being displayed. These experience schedule results 66 could be generated for instance, by the exemplary methods 200, 250 discussed above. In other embodiments, more or less experience search results 66 may be displayed, either on the same screen 52, or in subsequent screens 52 that may be viewed by selecting the navigation buttons 58, or by other means. In the illustrated embodiment, the first experience schedule result 66A includes three selected experiences 64 and one substitute experience 68A that was inserted by the system 10 or method 200 and/or 250 due to a lack of availability of inventory for the experience, conflict with another event outside of the experience area 22, conflict with the schedule of another member of the guest party, etc. for one of the selected experiences 64.

Additionally, this attraction schedule result 66A lists the time frame as morning (9 am-12 pm). If the guest desires this schedule of selected attractions 64 and substitute experience 68A, he can activate the select button 72. In some embodiments, additional members of the guest's party would be able to then review and/or select their own experience schedule results 66A. When all of the experience schedule results 66A for the guest party have been selected, the acceptance button 56 may be activated to cause the system 10 and/or method 200 or 250 to create a schedule for the guest's visit, including appointments and/or passes.

In some embodiments, rather than selecting substitute experiences 68A, the system may instead schedule the selected experiences 64 that may be scheduled and return a partial result, with instructions for the guest to fill the empty slots with new selected experiences 64. This may lead to the potential for guests to reserve partial schedules, which may not allow for the guest to take advantage of the benefits of the system 10 or method 200 and/or 250. In other embodiments, such as that illustrated in FIG. 6C, a second experience schedule result 66B is returned. For this experience schedule result 66B, two selected experiences 64 have been scheduled, as well as two substitute experiences 68B, 68C. In some embodiments, the guest may scroll over, or select the substitute experiences 68B or 68C to see a menu, list, or pop-up of additional available experiences 18 that may be chosen and/or recommended substitute experiences 68 that may be chosen. Additionally, when an experience schedule result 66A, 66B is presented, a map or a link to map of the experience area 22 may also be presented, and in some embodiments, the route 20 may be displayed on the map so that the guest can see the route 20 before choosing an experience schedule result 66A, 66B.

As illustrated in FIG. 6D, once all of the experience schedule results 66A, 66B have been chosen and the schedules generated, the guest will be able to see the schedules for each individual 54 in the guest party. Additionally, each individual 54 will be able to customize the schedule before the appointment(s) are made for the guest. For example, if individual 54B decided that he wanted to visit selected experience 1 in the 9:00 am slot rather than the currently scheduled selected experience 2 64B, the individual 54B could make that change. In some embodiments, the individual 54B would be able to display or see a map of the experience area 22 with both the original schedule and the customized schedule so that the individual 54B would understand how the change would alter the routing through the experience area 22.

Once all of the schedules have been customized, including any customization or scheduling of events, dining, leisure activities, etc., across all of the experience areas 22 to be visited, the navigation button 58 labeled “Done” or the like may be activated to initiate the appointment and/or payment process. In the exemplary embodiment, the appointment may be held or maintained for a set period, and the guest and/or any individual 54 would be able to view and/or alter the appointment.

Certain steps in the processes or process flows described in this description naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Therefore, although selected aspects have been illustrated and described in detail, it will be understood that various substitutions and alterations may be made therein without departing from the spirit and scope of the present invention, as defined by the following claims.

What is claimed is:

1. A computer program product comprising a computer usable medium having a computer readable program code embodied therein, said computer readable program code adapted to be executed to implement a method for managing a guest visit, said method comprising:
receiving information from a guest;
determining a guest strategy based on the information received from the guest; and
generating a schedule for the guest visit based on the guest strategy, wherein the schedule for the guest visit includes attendance at one or more experience areas.

2. The method of claim 1, wherein the step of receiving information from a guest comprises receiving information about the guest.

3. The method of claim 1, wherein the step of receiving information from a guest comprises receiving information about at least one experience the guest wishes to have at the one or more experience areas.

4. The method of claim 1, wherein the one or more experience area comprises one or more of a theme park, an amusement park, a resort, a hotel property, a golf course or a spa.

5. The method of claim 1, further comprising the step of identifying the guest from the information received from the guest.

6. The method of claim 5, wherein the step of identifying the guest comprises one or more of retrieving information about the guest from a prior visit, identifying the individuals that comprise the guest, or identifying additional schedules previously generated for the guest.

7. The method of claim 1, wherein the step of determining a guest strategy comprises applying business rules to the information received from the guest.

8. The method of claim 7, wherein at least one of the business rules benefits someone other than the guest.

9. The method of claim 1, wherein the step of generating a schedule for the guest comprises generating a schedule for attendance at one or more first experience areas on a first day and attendance at one or more second experience areas on a second day.

10. The method of claim 1, further comprising the step of evaluating the guest schedule.

11. The method of claim 10, wherein the step of evaluating the guest schedule comprises comparing one or more schedule with the information received from the guest.

12. A computer system comprising:
a guest experience manager, wherein the guest manager includes:
a guest interface capable of receiving a communication from a guest computer, the communication from the guest computer providing guest information,
at least one business rule for determining a guest strategy based at least in part on the guest information; and
a scheduling element in communication with the guest experience manager, the scheduling element capable of scheduling at least one experience based on the guest strategy.

13. The computer system of claim 12, wherein the guest information further includes at least one desired experience.

14. The computer system of claim 12, wherein the experience comprises one or more of a ride, live entertainment, parade, recorded entertainment, restaurant, golf course, or a spa treatment.

15. The computer system of claim 14, wherein the at least one experience is located in an experience area, the experience area comprising one or more of a theme park, an amusement park, a resort, a hotel property, a golf course or a spa.

16. The computer system of claim 15, further comprising one or more experience area computer located at or near the experience area.

17. The computer system of claim 16, wherein one of the one or more experience area computers comprises a kiosk at an experience within the experience area.

18. The computer system of claim 16, wherein one of the one or more experience area computers comprises a personal computing device operated by an attendant of an experience within the experience area.

19. The computer system of claim 12, wherein the guest strategy depends on the type or identity of the guest.

20. The computer system of claim 12, wherein the guest strategy depends on one or more of the number of days the guest will visit, where the guest will stay, or how many experience areas the guest will visit.
